(19) United States
(12) Patent Application Publication
(10) Pub. No.: US 2014/0050654 A1
(43) Pub. Date: Feb. 20, 2014

(54) CERIA-ZIRCONIA-MIXED OXIDE PARTICLES AND PROCESS FOR THEIR PRODUCTION BY PYROLYSIS

(71) Applicants: Stefan Hannemann, Mannheim (DE); Dirk Großschmidt, Mannheim (DE); Mirko Arnold, Bedminster, NJ (US); Gerd Grubert, Hannover (DE); Olga Gerlach, Ludwigshafen (DE); Andreas Sundermann, Bensheim (DE); Stefan Kotrel, Weinheim (DE)

(72) Inventors: Stefan Hannemann, Mannheim (DE); Dirk Großschmidt, Mannheim (DE); Mirko Arnold, Bedminster, NJ (US); Gerd Grubert, Hannover (DE); Olga Gerlach, Ludwigshafen (DE); Andreas Sundermann, Bensheim (DE); Stefan Kotrel, Weinheim (DE)

(73) Assignee: BASF SE, Ludwigshafen (DE)

(21) Appl. No.: 13/965,615

(22) Filed: Aug. 13, 2013

Related U.S. Application Data
(60) Provisional application No. 61/682,812, filed on Aug. 14, 2012.

(51) Int. Cl. B01J 23/10; C01B 13/00

(52) U.S. Cl. CPC B01J 23/10; C01B 13/00
USPC 423/579; 502/439; 502/303; 502/304

(57) ABSTRACT

Described is a process for the production of mixed oxide particles. The process comprises providing a mixture comprising a solvent, one or more precursor compounds of ceria, one or more precursor compounds of zirconia, and one or more precursor compounds of one or more rare earth oxides other than ceria and/or one or more precursor compounds of yttria; forming an aerosol of the mixture; and pyrolyzing the aerosol of to obtain mixed oxide particles. The content of the rare earth oxides other than ceria and/or of yttria in the mixed oxide particles is comprised in the range of from 0.1 to 4.9 wt.-% based on the total weight of the rare earth oxides, yttria, and zirconia contained in the mixed oxide particles. Also describes are mixed oxide particles obtained from flame spray pyrolysis and to their use as an oxygen storage component, a catalyst, and/or as a catalyst support.

### CROSS-REFERENCE TO RELATED APPLICATIONS

This application claims the benefit of priority under 35 U.S.C. §119(e) to U.S. Provisional Application No. 61/682,812, filed Aug. 14, 2012, the entire content of which is incorporated herein by reference in its entirety.

### TECHNICAL FIELD

The present invention relates to a process for the production of mixed oxide particles comprising ceria and zirconia, as well as to mixed oxide particles obtained by the inventive process, and, in particular, from flame spray pyrolysis. Furthermore, the present invention relates to the use of mixed oxide particles obtained according to the inventive process.

### BACKGROUND

In the field of exhaust gas treatment, and, in particular, in methods for the combustive or oxidative treatment thereof employing oxygen storage components (OSC), cerium and zirconium containing mixed oxides have found use therein, in particular as OSC component in automotive catalysts. As regards the methods for their production, a variety of processes have been employed such as solid state synthesis (e.g. ceramic method and mechanical grinding), liquid to solid synthesis (e.g. precursor method), various precipitation methods, hydrothermal and solvothermal synthesis, sol-gel methods, emulsion and microemulsion methods, impregnation methods, as well as gas to solid synthesis (e.g. chemical vapor deposition).

In practice, co-precipitation methods have found wide use. In these cases, from a solution of salts of the desired products, the oxides are precipitated with the aid of precipitation or flocculating agents. In these methods, the solubility of the individual compounds plays an important role. In particular, the solubility of the individual compounds must be very similar for avoiding a separation of phases. As a result of this, the use of said method with mixtures consisting of more than two cations becomes difficult. A further disadvantage in these methods is the formation of large amounts of salt containing waste materials during the production of such mixed oxide particles. In addition to this, co-precipitation methods necessitate a considerable number of workup steps including washing, filtration, drying, and calcination.

Various studies have shown that flame spray synthesis (FSS) and, in particular, flame spray pyrolysis (FSP) are suitable for producing oxygen storage materials displaying an improved thermal stability. Thus, Stark et al. in Chem. Comm. 2003, pp. 588-589 were able to produce ceria-zirconia mixed oxides with high surface areas having satisfactory oxygen storage characteristics using such spray flame synthetic methods. In Stark et al. in Chem. Mater. 2005, vol. 17, pp. 3352-3358 ceria-zirconia mixed oxides were produced via flame synthesis for attempting to obtain materials having an improved oxygen storage capacity at lower temperatures. Furthermore, Stark et al. in Chem. Mater. 2005, vol. 17, pp. 3352-3358 concerns the flame synthesis of ceria-zirconia mixed oxides further including platinum which may be obtained using a single step of flame synthesis.

In analogy to the co-precipitation methods, flame spray synthesis has also been used for producing ceria-zirconia mixed oxides containing further additives such as e.g. silica and alumina. Thus, in Schulz et al. in J. Mater. Chem. 2003, vol. 13, pp. 2979-2984 it was found that smaller amounts of silica were able to improve the oxygen storage capacity whereas alumina apparently had no effect thereon. Larger amounts of additives were found to be disadvantageous since these led to the formation of layers which would inhibit the oxygen exchange in the particles.

Jossen et al. Chem. Vap. Deposition 2006, vol. 12, pp. 614-619 investigated the thermal stability of ceria-zirconia mixed oxides using flame spray synthesis. In particular, it was found that ceria-zirconia mixed oxides having a cerium content of 35 wt.-% allowed for a production of particles with a high surface area which show an increased resistance to thermal aging. Furthermore, it was found that the addition of aluminum oxide and lanthanum oxide was able to improve the thermal stability. In this respect, the optimum as regards the stabilization effect was found for a mixed oxide consisting of 10 wt.-% lanthanum, 25 wt.-% cerium, and 65 wt.-% zirconium based on the total weight of the rare earth oxides and zirconium oxides.

Wang et al. in Journal of Molecular Catalysis A: Chemical 2011, vol. 339, pp. 52-60 relates to co-precipitated ceria-zirconia mixed oxides of the formula Ce_{0.2}Zr_{0.8}O₂ containing 5 wt.-% of rare earth elements such as lanthanum, neodymium, praseodymium, samarium, and yttrium. Wang et al. in Environmental Science and Technology 2010, vol. 44, pp. 3870-3875 concerns ceria-zirconia mixed oxides of the formula Ce_{0.2}Zr_{0.8}O₂ modified with rare earth elements and in particular with lanthanum, neodymium, praseodymium, samarium, and yttrium as well as their use in a three way catalyst for the treatment of automotive exhaust gases, wherein the rare earth containing ceria-zirconia mixed oxide is obtained by a co-precipitation method. In particular, it was respectively found in Wang et al. that the addition of 5 wt.-% of rare earth oxides to Ce_{0.2}Zr_{0.8}O₂ had the effect of improving the thermostability as well as the oxygen storage capacity of the resulting material. In particular, the addition of lanthanum, neodymium, and praseodymium showed a clear improvement in comparison with the pure ceria-zirconia mixed oxides. These materials, however, were not produced using flame spray synthesis but rather using a co-precipitation method. Li et al. in Journal of Rare Earths 2011, vol. 29, no. 6, pp. 544-549, relate to a ceria-zirconia mixed oxide Ce_{0.8}Zr_{0.2}O₂ containing 5 wt.-% lanthana and which has been produced by a co-precipitation method. Cao et al. in Materials Letters 2008, vol. 62, pp. 2667-2669 on the other hand concerns an oxide ceramic material of the formula La₂(Ce_{0.7}Zr_{0.3})₂O₇ which is obtained from solid state synthesis.

US 2011/0281112 A1 relates to a method of producing ceria using flame spray pyrolysis.

Stark et al. in Chemical Communications 2003, pp. 588-589, WO 2004/103900 A1, and WO 2004/005184 A1 respectively relate to the production of ceria-zirconia mixed oxides using flame spray pyrolysis methods. EP 1 378 489 A1 concerns a method for the production of mixed metal oxides from flame synthesis and in particular to ceria-zirconia mixed oxides having high zirconium levels.

U.S. Pat. No. 7,220,398 B2 concerns ceria-zirconia mixed oxide including alumina which are formed via flame spray pyrolysis, wherein the particles consist of gamma-alumina onto which a solid solution of ceria and zirconia segregate.

Although improvements have been made relative to the methods of obtaining mixed oxide materials containing various additives in addition to the main components and in particular ceria and zirconia, there remains an ongoing need for high performance oxygen storage components which may be produced in a highly efficient and thus cost effective manner for providing cost effective materials. This applies in particular with respect to oxygen storage component materials employed in automotive catalysts which to a large extent is motivated by the costs of the precursor materials and in particular of additives employed in ceria-zirconia mixed oxides for improving their properties. Thus, although improvements have been achieved in view of the flame spray pyrolysis methods which may be performed in a single step, there remains the problem that such methods nevertheless involve the use of larger amounts of precursor materials and in particular of ceria and other rare earth compounds as additive materials for providing the desired performance in oxygen storage capacity in the resulting materials.

### SUMMARY

Embodiments of a first aspect of the present invention are directed to a process for the production of mixed oxide particles. According to one or more embodiments, the process comprises providing a mixture comprising a solvent, one or more precursor compounds of ceria, one or more precursor compounds of zirconia, and one or more precursor compounds of one or more rare earth oxides other than ceria and/or one or more precursor compounds of yttria; forming an aerosol of the mixture; and pyrolyzing the aerosol to obtain mixed oxide particles. In one or more embodiments, the content of the rare earth oxides other than ceria and/or of yttria in the mixed oxide particles is in the range of from 0.1 to 4.9 wt.-% based on the total weight of the rare earth oxides, yttria, and zirconia contained in the mixed oxide particles.

In one or more embodiments, the one or more rare earth oxides other than ceria is selected from the group consisting of lanthana, praseodymia, neodymia, and mixtures of two or three thereof. In other embodiments, the concentration of the one or more precursor compounds of the one or more rare earth oxides other than ceria and/or of the one or more precursor compounds of yttria calculated as the respective oxides contained in the mixture is comprised in the range of from to 0.01 to 5 wt.-% based on the total weight of the mixture.

In one or more embodiments, the solvent comprises one or more selected from the group consisting of aliphatic and aromatic hydrocarbons, alcohols, heterocyclic compounds, carboxylic acids, water, and mixtures of two or more thereof. In one or more embodiments, the aromatic hydrocarbons comprise one or more aromatic hydrocarbons selected from the group consisting of (C₆-C₁₂)hydrocarbons. In one or more embodiments, the aliphatic hydrocarbons comprise one or more hydrocarbons selected from the group consisting of branched and/or unbranched (C₄-C₁₂)hydrocarbons. In specific embodiments, the carboxylic acid is selected from the group consisting of (C₁-C₈) carboxylic acids.

In one or more embodiments, the concentration of the one or more precursor compounds of ceria calculated as CeO₂ contained in the mixture is comprised in the range of from 0.1 to 15 wt.-% based on the total weight of the mixture. According to one or more embodiments, the concentration of the one or more precursor compounds of zirconia calculated as ZrO₂ contained in the mixture is comprised in the range of from 0.1 to 15 wt.-% based on the total weight of the mixture.

In one or more embodiments, the one or more precursor compounds of ceria and/or of the rare earth oxides other than ceria and/or of yttria comprise one or more salts. In one or more embodiments, the chelating ligand containing complexes comprise one or more chelating ligands selected from the group consisting of bi-, tri-, tetra-, penta-, and hexadentate ligands. In specific embodiments, the one or more precursor compounds of zirconia comprise one or more salts.

In one or more embodiments, the mixture further comprises one or more platinum group metals. According to one or more specific embodiments, the mixture comprises the one or more platinum group metals in an amount ranging from 0.01 to 15 wt.-% calculated as the metal based on the total weight of the mixture.

In one or more embodiments, pyrolysis is performed in an atmosphere containing oxygen. In further embodiments, pyrolysis is performed at a temperature in the range of from 800 to 2,200° C.

Embodiments of a second aspect of the present invention are directed to a mixed oxide particle obtained by the process according to one or more embodiments.

Embodiments of a third aspect of the present invention are directed to a mixed oxide particle obtained from flame spray pyrolysis. According to one or more embodiments, the particles comprise ceria, zirconia, and one or more oxides of one or more rare earth elements other than Ce, and/or yttria, wherein the content of the rare earth oxides other than ceria, and/or of yttria in the mixed oxide calculated as their respective oxides is comprised in the range of from 0.1 to 4.9 wt.-% based on the total weight of the one or more rare earth oxides, zirconia, and optional yttria contained in the mixed oxide particles.

In one or more embodiments, the one or more rare earth oxides other than ceria are selected from the group consisting of lanthana, praseodymia, neodymia, and combinations of two or three thereof.

In specific embodiments, the content of ceria in the mixed oxide particles is comprised in the range of from 1 to 95 wt.-% based on the total weight of the one or more rare earth oxides, zirconia, and optional yttria contained in the mixed oxide particles. In one or more embodiments, the content of ZrO₂ in the mixed oxide particles is comprised in the range of from 1 to 95 wt.-% based on the total weight of the one or more rare earth oxides, zirconia, and optional yttria contained in the mixed oxide particles.

In one or more embodiments, the BET surface area of the mixed oxide particles is comprised in the range of from 2 to 200 m²/g. In other embodiments, the average particle size of the mixed oxide particles is comprised in the range of from 5 to 100 nm.

In one or more embodiments, the proportion of the cubic phase as determined according to the Rietveld method is comprised in the range of from 0.1 to 29%. In specific embodiments, the proportion of the cubic phase as determined according to the Rietveld method after aging of the mixed oxide particles is comprised in the range of from 30 to 100%.

Embodiments of a further aspect of the present invention are directed to the use of the mixed oxide particles obtained by the process according to one or more embodiments as a catalyst, a catalyst support, or an oxygen storage component.

### BRIEF DESCRIPTION OF DRAWINGS

FIG. 1 shows the oxygen storage capacity of mixed oxide materials obtained from flame spray pyrolysis according to the Examples;

FIG. 2 shows the BET-surface area of mixed oxide materials according to the Examples;

FIG. 3 displays the burner configuration (top and side view) in an apparatus which may be employed for flame spray pyrolysis.

### DETAILED DESCRIPTION

Provided is an improved process for the production of ceria-zirconia mixed oxides. In particular, it is the aim of the present invention to provide a ceria-zirconia mixed oxide material having an excellent oxygen storage capacity and aging resistance in particular relative to the amount of the costly precursor compounds ceria and further additives including rare earth oxides other than ceria for providing the desired features and performance of the oxygen storage materials.

Thus, it has quite surprisingly been found that ceria-zirconia mixed oxide particles containing a very low amount of one or more further rare earth metals other than ceria and/or containing a very low amount of yttria may be obtained from flame synthesis which offer an unexpectedly high performance based on the amount of said rare earth elements other than ceria and/or of yttria contained therein. More specifically, it has quite unexpectedly been found that relative to the oxygen storage capacity of such materials based on the amounts of rare earth metal oxide other than ceria and/or of yttria contained therein considerably less of said materials are necessary for achieving a comparable of even an improved performance compared to ceria-zirconia based mixed oxide materials known in the art.

Therefore, according to one or more embodiments, provided is a process for the production of mixed oxide particles comprising:
(1) providing a mixture comprising a solvent, one or more precursor compounds of ceria, one or more precursor compounds of zirconia, and one or more precursor compounds of one or more rare earth oxides other than ceria and/or one or more precursor compounds of yttria;
(2) forming an aerosol of the mixture provided in step (1); and
(3) pyrolyzing the aerosol of step (2), in specific embodiments in an atmosphere containing oxygen, to obtain mixed oxide particles;
   wherein the content of the rare earth oxides other than ceria and/or of yttria in the mixed oxide particles formed in step (3) is in the range of from 0.1 to 4.9 wt.-% based on the total weight of the rare earth oxides, yttria, and zirconia contained in the mixed oxide particles, in specific embodiments from 0.3 to 4.5 wt.-%, in more specific embodiments from 0.5 to 4 wt.-%, in very specific embodiments from 0.7 to 3.5 wt.-%, from 0.8 to 3 wt.-%, from 0.9 to 2.5 wt.-%, and in even more specific embodiments from 1 to 2 wt.-%.

As regards the provision of the mixture in step (1) of the inventive process, there is no particular restriction as to the means which are employed for forming a mixture provided that a homogenous mixture may be provided. Thus, according to the present invention, in instances wherein one or more of the precursor compounds is at least in part insoluble in the solvent provided for forming the mixture, means of homogenizing the mixture are employed for achieving a high dispersion of said one or more precursor compounds therein. Thus, by way of example, in such cases the homogenous mixture may be provided by appropriate means of agitation such as by stirring, shaking, rotating, and sonication, wherein in one or more embodiments the mixture is provided by appropriate stirring of the one or more precursors in the solution for providing a high dispersion thereof. According to the present invention, however, in one or more embodiments, the one or more precursor compounds provided in step (1) are respectively soluble in the solvent which is provided such that a homogenous mixture is provided by dissolution of all components in the solvent.

Concerning the formation of an aerosol in step (2), on the other hand, there is again no particular restriction according to the present invention as to the means which may be employed for forming such an aerosol provided that it may be pyrolysed in step (3) of the inventive process. Thus, by way of example, the aerosol may be formed by any appropriate means for dispersing the mixture provided in step (1) in a gaseous medium such as by spraying the mixture provided in step (1) into said medium. According to a specific embodiment of the present invention, the mixture provided in step (1) is sprayed into a gas stream for obtaining a stream of said aerosol which may then be conducted into a pyrolysing zone for achieving step (3) of the inventive process.

As regards the step of pyrolysing of the aerosol provided in step (2) of the inventive process, there is again no particular restriction as to the method which is employed for achieving said pyrolysis, provided that at least a portion of the aerosol is converted to mixed oxide particles as a result of said thermal treatment. Thus, be way of example, the pyrolysis in step (3) may be achieved with the aid of any suitable heat source of which the temperature is sufficient for pyrolysing at least a portion of the aerosol provided in step (2). According to the present invention, the process for the production of mixed oxide particles is conducted in a continuous mode, wherein the aerosol according to particular embodiments of the present invention is provided as a gas stream which is allowed to pass a pyrolysing zone for obtaining mixed oxide particles from at least a portion of said aerosol in the gas stream exiting the pyrolysing zone. According to said embodiments of the present invention wherein the pyrolysis is conducted in a continuous mode, there is no particular restriction as to the weight hourly space velocity of the aerosol gas stream which is conducted to the pyroylsing zone, nor is there any restriction as to the extent of the pyrolysing zone provided that the weight hourly space velocity is chosen such depending on the extent of the pyrolysing zone at least a portion of the aerosol may be pyrolysed in step (3) for obtaining mixed oxide particles.

As regards the gas in which the aerosol is formed in step (2) of the inventive process, there is again no particular restriction regarding its composition such that it may contain one type of gas or several different types of gases. Accordingly, the gas employed for providing the aerosol in step (2) may consist of one or more inert gases, wherein according to the present invention said one or more inert gases do not react under the conditions of pyrolysis in step (3) of the inventive process. According to the present invention, in specific embodiments at least a portion of the gas employed for forming an aerosol in step (2) is a gas which reacts with at least a portion of the mixture provided in step (1), wherein, in further specific embodiments, said gas has an oxidizing effect on the mixture provided in step (1), in particular during pyrolysis of the mixture in step (3). According to said embodiments wherein at least a portion of the gas contained in the aerosol formed in step (2) acts as an oxidizing agent towards the mixture in step (1), there is no particular restriction as to the type of gas which may be used to this effect provided that it may oxidize at least a portion of the mixture provided in step (1). According to said embodiments of the present invention, in one or more specific embodiments, the portion of the gas contained in the aerosol provided in step (2) which has an oxidizing effect on the mixture provided in step (1) reacts with at least a portion of the mixture during pyrolysis in step (3), wherein said reaction is exothermic for providing at least a portion of the heat source required in step (3) for the pyrolysis of the mixture provided in step (1). As regards the type of gas which may be used according to said specific embodiments, there is again no particular restriction provided that it may react with at least a portion of the mixture provided in step (1) in an exothermic fashion for providing at least part of the heat necessary for the pyrolysis in step (3). According to specific embodiments of the present invention, the oxidizing gas comprised in the aerosol in step (2) comprises oxygen, wherein, in more specific embodiments, the oxidizing gas contained in the aerosol of step (2) is oxygen.

As regards the one or more precursor compounds of zirconia provided in step (1) it is noted that within the meaning of the present invention, the term “zirconia” designates zirconia, hafnia, and mixtures thereof.

Concerning the mixture provided in step (1) of the inventive process, there is no particular restriction as to the amounts of the solvent, nor with respect to the amount of the one or more precursor compounds of ceria, zirconia, or of the one or more rare earth oxides other than ceria and/or of yttria, provided that depending on the specific parameters and conditions which are employed in the steps of providing the mixture in step (1), of forming the aerosol from said mixture in step (2), and of pyrolysing the aerosol in step (3), at least a portion of the mixed oxide particles formed in step (3) requires rare earth oxides other than ceria and/or yttria in an amount in the range of from 0.1 to 4.9 wt.-% based on the total weight of the rare earth oxides, yttria, and zirconia contained in the mixed oxide particles. According to a particular meaning of the present invention, at least a portion of the mixed oxide particles formed in step (3) contain the rare earth oxides other than ceria and/or yttria in an amount comprised in the range of from 0.1 to 4.9 wt.-% based on the total weight of the rare earth oxides, yttria, and zirconia contained in the mixed oxide particles when at least part of the individual mixed oxide particles formed in step (3) fulfill this definition, wherein, in specific embodiments, at least 50% of the individual mixed oxide particles formed in step (3) contain the one or more rare earth oxides other than ceria and/or yttria in an amount comprised in the range of from 0.1 to 4.9 wt.-% based on the total weight of the rare earth oxides, yttria, and zirconia contained in the mixed particles, in one or more embodiments 60 wt.-% or more of the mixed oxide particles formed in step (3), in other embodiments 70 wt.-% or more, in further embodiments 80 wt.-% or more, in still further embodiments 90 wt.-% or more, in specific embodiments 95 wt.-% or more, in very specific embodiments 98 wt.-% or more, in even more specific embodiments 99 wt.-% or more, and in still more specific embodiments 99.5 wt.-% or more. According to specific embodiments of the present invention, 99.9 wt.-% or more of the mixed oxide particles formed in step (3) contain one or more of the rare earth oxides other than ceria and/or yttria in an amount comprised in the range of from 0.1 to 4.9 wt.-% based on the total weight of the rare earth oxides and zirconia contained in the mixed oxide particles, wherein said content of rare earth oxides other than ceria refers to the content in the individual particles of the mixed oxide. Same applies accordingly relative to the further specific embodiments of the present invention wherein the content of the rare earth oxides other than ceria in the mixed oxide particles formed in step (3) is comprised in the range of from 0.3 to 4.5 wt.-%, in more specific embodiments from 0.5 to 4 wt.-%, in very specific embodiments from 0.7 to 3.5 wt.-%, from 0.8 to 3 wt.-%, from 0.9 to 2.5 wt.-%, and even more specific embodiments of from 1 to 2 wt.-%.

As regards the one or more rare earth oxides other than ceria provided in step (1) of the inventive process, there is no particular restriction according to the present invention neither with respect to the type nor with respect to the number of the one or more precursor compounds of one or more rare earth oxides other than ceria which may be provided. According to the present invention, in one or more embodiments, said one or more rare earth oxides other than ceria comprise one or more of lanthana, praseodymia, and neodymia, including mixtures of two or three thereof, wherein, in specific embodiments, the one or more rare earth oxides other than ceria comprise lanthana and/or neodymia. According to more specific embodiments of the present invention, the one or more rare earth oxides other than ceria provided in step (1) of the inventive process include lanthana, wherein, in very specific embodiments, the rare earth oxide other than ceria is lanthana. According to the present invention, unless otherwise specified, the designation of the rare earth oxides does not refer to a particular type thereof, in particular relative to the oxidation state of the rare earth metal, such that in principle any one or more rare earth oxides may be designated. Thus, by way of example, unless otherwise specified, the term “ceria” principally refers to the compounds CeO₂, Ce₂O₃, and any mixtures of the aforementioned compounds. According to one or more embodiments, however, the term “ceria” designates the compound CeO₂. The same applies accordingly relative to the term “praseodymia” such that, in general, said term designates any one of the compounds Pr₂O₃, Pr₆O₁₁, PrO₂, and any mixtures of two or more thereof. According to one or more embodiments of the present invention, the term “praseodymia” designates the compound Pr₂O₃.

Therefore, according to one or more embodiments of the inventive process, the one or more rare earth oxides other than ceria is selected from the group consisting of lanthana, praseodymia, neodymia, and mixtures of two or three thereof, wherein the one or more rare earth oxides, in specific embodiments, comprises lanthana and/or neodymia, preferably lanthana, wherein, in very specific embodiments, the rare earth oxide other than ceria is lanthana.

Concerning the concentration of the one or more precursor compounds of the one or more rare earth oxides other than ceria, there is again no particular restriction according to the present invention as to the amounts in which said compounds may be provided in step (1) of the inventive process provided that depending on the specific means for its execution and the parameters chosen therein the content of the rare earth oxides other than ceria and/or of yttria in the mixed oxide particles formed in step (3) is comprised in the range of from 0.1 to 4.9 wt.-% based on the total weight of the rare earth oxides, yttria, and zirconia contained in the mixed oxide particles. The same applies accordingly with respect to the one or more precursor compounds of yttria according to embodiments containing the same. Thus by way of example, the concentration of the one or more precursor compounds of the one or more rare earth oxides other than ceria and/or of the one or more precursor compounds of yttria calculated as their respective oxides contained in the mixture provided in step (1) may be comprised in the range of anywhere from 0.01 to 5 wt.-% based on the total weight of the mixture provided in step (1), wherein in one or more embodiments the concentration thereof is comprised in the range of from 0.05 to 2 wt.-%, in other embodiments from 0.1 to 1.5 wt.-%, in specific embodiments from 0.3 to 1.2 wt.-%, in more specific embodiments from 0.5 to 1 wt.-%, and in very specific embodiments from 0.7 to 0.9 wt.-%. According to specific embodiments of the present invention, the concentration of the one or more precursor compounds of the one or more rare earth oxides other than ceria and/or of the one or more precursor compounds of yttria calculated as their respective oxides is comprised in the range of from 0.75 to 0.85 wt.-% based on the total weight of the mixture provided in step (1).

As concerns the solvent provided in step (1) of the inventive process, there is again no particular restriction neither with respect to the composition nor with respect to the amount of said solvent provided that the content of the rare earth oxides other than ceria and/or of yttria in the mixed oxide particles formed in step (3) is comprised in the range of from 0.1 to 4.9 wt.-%. Thus, by way of example, the solvent provided in step (1) may comprise one or more compounds such as those selected from the group consisting of aliphatic and aromatic hydrocarbons, alcohols, heterocyclic compounds, carboxylic acids, water, and mixtures of any two or more thereof. According to specific embodiments, the solvent provided in step (1) of the inventive process comprises one or more selected from the group consisting of aromatic hydrocarbons, N-containing heterocycles, tetrahydrofurane, (C₅-C₁₀)hydrocarbons, (C₁-C₅)alcohols, (C₁-C₈)carboxylic acids, water, and combinations of two or more thereof, in one or more embodiments from the group consisting of (C₆-C₁₂) aromatic hydrocarbons, pyrrolidine, pyrrole, piperidine, pyridine, azepane, azepine, tetrahydrofurane, (C₅-C₇)hydrocarbons, (C₁-C₃)alcohols, (C₂-C₈)carboxylic acids, water, and combinations of two or more thereof, in specific embodiments from the group consisting of C₈ aromatic hydrocarbons, pyrrolidine, pyrrole, piperidine, pyridine, tetrahydrofurane, pentane, hexane, ethanol, methanol, propanol, (C₆-C₈)carboxylic acids, acetic acid, propionic acid, water, and combinations of two or more thereof, in other embodiments from the group consisting of toluene, ethylbenzene, xylene, hexane, propanol, acetic acid, C₈-carboxylic acids, propionic acid, water, and combinations of two or more thereof, and in very specific embodiments from the group consisting of xylene, hexane, n-propanol, acetic acid, 2-ethylhexanoic acid, water, and combinations of two or more thereof.

According to the present invention, it is not necessary that the solvent provided in step (1) be in the liquid state at room temperature. Within the meaning of the present invention, the term “room temperature” refers to a temperature of about 25° C. Thus, according to particular embodiments of the present invention, the solvent provided in step (1) is not in a liquid state but rather in a solid or semi-solid state at room temperature and the mixture provided in step (1) is employed in the inventive process at a temperature greater than room temperature for forming an aerosol in step (2). According to said embodiments, the solvent provided in step (1) therefore comprises one or more compounds having a melting point above room temperature, wherein said one or more compounds may accordingly be selected from the group consisting of higher molecular weight aliphatic and aromatic hydrocarbons, alcohols, heterocyclic compounds, carboxylic acids, and mixtures of two or more thereof, wherein said compounds have melting points above room temperature, respectively. According to the present invention, said one or more higher molecular weight compounds having melting points above room temperature may be comprised in the solvent provided in step (1) together with one or more compounds having a melting point at and/or below room temperature. According to particular embodiments of the present invention, however, the solvent provided in step (1) substantially consists of one or more compounds having a melting point above room temperature, wherein, according to one or more embodiments, said one or more compounds are selected from the group consisting of aliphatic and aromatic hydrocarbons, alcohols, heterocyclic compounds, carboxylic acids, and mixtures of two or more thereof, and in specific embodiments from the group consisting of aliphatic hydrocarbons, alcohols, carboxylic acids, and mixtures of two or more thereof.

According to one or more embodiments of the present invention, the solvent provided in step (1) comprises xylene. According to other embodiments of the present invention, the solvent provided in step (1) comprises a mixture of acetic acid and water.

As regards the aromatic hydrocarbons comprised in the solvent in step (1) of the inventive process, there is again no particular restriction relative to the particular type or types of aromatic hydrocarbons which may be employed in the inventive process provided that the content of the rare earth oxides other than ceria and/or of yttria in the mixed oxide particles formed in step (3) is comprised in the range of 0.1 to 4.9 wt.-% based on the total weight of the rare earth oxides, yttria and zirconia contained in the mixed oxide particles. Thus, by way of example, the aromatic hydrocarbons may be selected from the group consisting of (C₆-C₁₂)hydrocarbons, including any mixtures of two or more thereof, wherein, in one or more embodiments, the aromatic hydrocarbons comprise one or more (C₇-C₁₁)hydrocarbons, in other embodiments of (C₈-C₁₀)hydrocarbons, in specific embodiments of (C₈-C₉)hydrocarbons, and in more specific embodiments of C₈-hydrocarbons, wherein in one or more embodiments the solvent comprises one or more aromatic hydrocarbons selected from the group consisting of toluene, ethylbenzene, xylene, mesitylene, durene, and mixtures of two or more thereof, in other embodiments from the group consisting of toluene, ethylbenzene, xylene, and mixtures of two or more thereof, wherein in specific embodiments the solvent comprises toluene and/or xylene, preferably xylene.

The same applies accordingly relative to the aliphatic hydrocarbons comprised in the solvent provided in step (1) of the inventive process. Thus, as regards the aliphatic hydrocarbons which are comprised in the mixture provided in step (1) of the inventive process, these may in principle be any one or more branched or unbranched aliphatic hydrocarbons or any conceivable mixture of branched and/or unbranched hydrocarbons, wherein the aliphatic hydrocarbons are, in one or more embodiments, unbranched. According to said embodiments, the aliphatic hydrocarbons comprise one or more hydrocarbons selected from the group consisting of unbranched (C₄-C₁₂)hydrocarbons, in one or more embodiments of (C₅-C₁₀)hydrocarbons, in other embodiments of (C₆-C₈)hydrocarbons, in specific embodiments of (C₆-C₇)hydrocarbons, and in very specific embodiments of branched and/or unbranched, preferably unbranched C₆-hydrocarbons, wherein in one or more embodiments the solvent comprises one or more aliphatic hydrocarbons selected from the group consisting of pentane, hexane, heptane, octane, and mixtures of two or more thereof, wherein in very specific embodiments the aliphatic hydrocarbons comprise pentane and/or hexane, preferably hexane.

As for the hydrocarbons which are comprised in the mixture provided in step (1) of the inventive process, there is also no particular restriction which would apply relative to the carboxylic acids comprised in the mixture provided in step (1) according to embodiments of the inventive process, provided again that the content of the rare earth oxides other than ceria and/or of yttria in the mixed oxide particles formed in step (3) as comprised in the range of from 0.1 to 4.9 wt.-% based on the total weight of the rare earth oxides, yttria and zirconia contained in the mixed oxide particles. Thus, by way of example, the one or more carboxylic acids may be selected from the group consisting of (C₁-C₈)carboxylic acids, wherein, in one or more embodiments, the one or more carboxylic acids are selected from the group consisting of (C₁-C₆)carboxylic acids, in other embodiments from the group consisting of (C₁-C₅)carboxylic acids, in specific embodiments from the group consisting of formic acid, acetic acid, propionic acid, butyric acid, and mixtures of two or more thereof, in very specific embodiments from the group consisting of acetic acid, propionic acid, butyric acid, 2-ethylhxanoic acid and mixtures of two or more thereof, wherein, in one or more specific embodiments, the carboxylic acid comprises acetic acid and/or propionic acid, preferably acetic acid.

As regards the one or more precursor compounds of ceria comprised in the mixture provided in step (1) of the inventive process, there is no particular restriction neither with respect to the particular type or number of precursor compounds which may be employed nor with respect to the amount in which they may be provided in the mixture provided that depending on the further components provided in the mixture and the specific means of executing steps (1), (2), and (3) of the inventive process affords mixed oxide particles in step (3) of which the content of rare earth oxides other than ceria and/or of yttria is comprised in the range of from 0.1-4.9 wt.-% based on the total weight of the rare earth oxides, yttria and zirconia contained in the mixed oxide particles. The same applies accordingly with respect to the one or more precursor compounds of zirconia as well as with respect to the one or more precursor compounds of the one or more rare earth oxides other than ceria and with respect to the one or more precursor compounds of yttria. Thus, as regards the one or more precursor compounds of ceria and/or of the rare earth oxides other than ceria and/or of yttria comprised in the mixture provided in step (1), any one or more of said precursor compounds may be provided in any suitable form provided that their interaction with the solvent and/or with the further components of the mixture in step (1) as well as the specific methods for forming an aerosol employed in step (2) and the pyrolysis of the aerosol in step (3) allows for the formation of mixed oxide particles in step (3) of which the content of the rare earth oxides other than ceria and/or of yttria is comprised in the range of from 0.1 to 4.9 wt.-% based on the total weight of the rare earth oxides, yttria, and zirconia contained in the mixed oxide particles. Thus, by way of example, the one or more precursor compounds of ceria and/or of the rare earth oxides other than ceria and/or of yttria may be any suitable compound of the rare earth metals or yttrium, wherein, in one or more embodiments, the one or more salts of the rare earth metals and/or of yttrium be provided in step (1) of the inventive process. As regards the salts of the rare earth metals and/or of yttrium, any conceivable salts may again be employed, wherein, in specific embodiments, the one or more salts may completely dissolve in the solvent provided in step (1), wherein the type of salt chosen may accordingly depend on the type and amount of salts chosen for the other precursor compounds provided in step (1) and in particular on the type of solvent and the amount thereof provided in the mixture. Thus, according to the present invention, in one or more embodiments, the one or more precursor compounds of ceria and/or of the rare earth oxides other than ceria and/or of yttria comprise one or more salts selected from the group consisting of carboxylates, nitrates, carbonates, alcoholates, and chelating ligand containing complexes, wherein the carboxylates are, in one or more embodiments, selected from (C₄-C₁₂)carboxylates, more specifically from (C₅-C₁₁)carboxylates, in other embodiments from (C₆-C₁₀)carboxylates, in still further embodiments from (C₇-C₉)carboxylates, in specific embodiments from C₈-carboxylates, in very specific embodiments from branched C₈-carboxylate, wherein, in one or more embodiments, the one or more precursor compounds comprise a 2-ethylhexanoate salt, and wherein, in specific embodiments, the one or more precursor compounds of ceria and/or of the rare earth oxides other than ceria, and in other specific embodiments, all of the precursor compounds of the rare earth oxides provided in step (1) are 2-ethylhexanoate salts.

According to the present invention, in one or more embodiments, wherein the one or more precursor compounds comprise one or more salts, said salts do not lower the solubility of the one or more further precursor compounds as a result of the specific type of salt which is used. Furthermore, in one or more embodiments the salts which are used as the one or more precursor compounds do not have a negative impact on the apparatus which is used and in particular does not generate reactive side products which may damage said apparatus, e.g., by corrosion thereof. Accordingly, in specific embodiments of the present invention the mixture provided in step (1) does not contain any halides and in particular does not contain any fluorides, chlorides, and/or bromides and even more preferably does not contain any fluorides and/or chlorides. Within the meaning of the present invention, the mixture provided in step (1) does not contain any halides when no substantial amount of a halide-containing salt is present in the mixture provided in step (1), wherein the term “substantial” as employed for example in the terms “substantially not”, or “not any substantial amount of” within the meaning of the present invention respectively refer to there practically being not any amount of said component in the mixture provided in step (1) and/or in the aerosol formed in step (2) of the inventive process, wherein, in one or more embodiments, 0.1 wt.-% or less of said one or more components is contained therein based on the total weight of the mixture and/or of the liquids and/or solids contained in the aerosol, in other embodiments an amount of 0.05 wt.-% or less, in further embodiments of 0.001 wt.-% or less, in specific embodiments of 0.0005 wt.-% or less, and in more specific embodiments of 0.0001 wt.-% or less.

According to one or more embodiments of the present invention, wherein one or more chelating ligand-containing complexes are comprised as the one or more precursor compounds of ceria and/or of the rare earth oxides other than ceria and/or of yttria in the mixture provided in step (1), there is in principle no particular restriction as to the type or number of chelating ligand-containing complexes which may be comprised in said mixture. Thus, there is no particular restriction according to the present invention as to the type of the one or more chelating ligands such that said ligands may for example be selected from the group consisting of bi-, tri-, tetra-, penta-, and hexadentate ligands. According to one or more embodiments of the present invention, the chelating ligand-containing complexes comprise one or more chelating ligands selected from the group consisting of oxalate, ethylenediamine, 2,2′-bipyridine, 1,10-phenanthroline, acetylacetonate, 2,2,2-crypt, diethylenetriamine, dimethylglyoximate, EDTA, ethylenediaminetriacetate, glycinate, triethylenetetramine, tris(2-aminoethyl)amine, and combinations of two or more thereof, in other embodiments from the group consisting of oxalate, ethylenediamine, acetylacetonate, diethylenetriamine, dimethylglyoximate, EDTA, ethylenediaminetriacetate, glycinate, triethylenetetramine, tris(2-aminoethyl)amine, and combinations of two or more thereof, in further embodiments from the group consisting of oxalate, ethylenediamine, acetylacetonate, diethylenetriamine, EDTA, ethylenediaminetriacetate, triethylenetetramine, and combinations of two or more thereof, wherein in very specific embodiments, the chelating ligand containing complexes comprise acetylacetonate.

As regards the concentration of the one or more precursor compounds of ceria which may be contained in the mixture provided in step (1), as for the one or more precursor compounds of the one or more rare earth oxides other than ceria and/or of the one or more precursor compounds of yttria, there is again no particular restriction in this respect provided that depending on the type and amount of the other components provided in the mixture of step (1) and the specific steps and parameters chosen in steps (2) and (3) of the inventive process allow for the generation of mixed oxide particles of which the content of the rare earth oxides other than ceria and/or of yttria is comprised in the range of from 0.1 to 4.9 wt.-% based on the total weight of the rare earth oxides, yttria, and zirconia contained in the mixed oxide particles. Thus, by way of example, the concentration of the one or more precursor compounds of ceria calculated as CeO₂ contained in the mixture contained in step (1) may be comprised anywhere in the range of from 0.1 to 15 wt.-% based on the total weight of the mixture provided in step (1), wherein, in one or more embodiments, the concentration of the one or more precursor compounds of ceria is comprised in the range of from 0.5 to 10 wt.-%, in other embodiments from 1 to 7 wt.-%, in further embodiments from 2 to 5 wt.-%, in specific embodiments from 2.5 to 4 wt.-%, and in more specific embodiments from 2.7 to 3.5 wt.-%. According to specific embodiments of the present invention, the concentration of the one or more precursor compounds of ceria calculated as CeO₂ contained in the mixture provided in step (1) is comprised in the range of from 3 to 3.2 wt.-%.

As regards the one or more precursor compounds of zirconia provided in step (1) of the inventive process, as for the one or more precursor compounds of ceria or of the other precursor compounds of the one or more rare earth oxides other than ceria and/or of the one or more precursor compounds of yttria, again no particular restrictions apply in this respect for the same reasons as mentioned in the foregoing relative to the other components of the mixture in step (1). Thus, by way of example, the concentration of the one or more precursor compounds of zirconia calculated as ZrO₂ contained in the mixture provided in step (1) may be comprised in the range of anywhere from 0.1 to 15 wt.-% based on the total weight of the mixture provided in step (1), wherein the concentration of the one or more precursor compounds of zirconia is comprised in the range of from 0.5 to 10 wt.-%, in one or more embodiments of from 1 to 7 wt.-%, more in other embodiments of from 2 to 5 wt.-%, in specific embodiments of from 2.5 to 4 wt.-%, and in more specific embodiments of from 2.7 to 3.5 wt.-%. According to specific embodiments of the present invention, the concentration of the one or more precursor compounds of zirconia contained in the mixture provided in step (1) is comprised in the range of from 3 to 3.2 wt.-%.

Regarding the specific type of precursor compounds which may be employed as the one or more precursor compounds of zirconia, as for the one or more precursor compounds of ceria and of the one or more rare earth oxides other than ceria and/or of yttria, in principle any conceivable precursor compound or compounds of zirconium may be employed, wherein again one or more salts are employed as the one or more precursor compounds for the same reasons as given above with respect to the further one or more precursor compounds contained in the mixture according to step (1) of the inventive process. Thus, by way of example, the one or more salts of zirconium comprised in the mixture of step (1) comprise one or more salts selected from the group consisting of halides, carboxylates, nitrates, carbonates, alcoholates, and chelating ligand containing complexes, preferably diketone ligand containing complexes, and more preferably acetylacetonate complexes, wherein the alcoholates are preferably selected from (C₂-C₅) alcoholates, more preferably from (C₃-C₄) alcoholates, and more preferably from C₃-alcoholates, wherein more preferably the one or more precursor compounds comprise zirconium(IV)-propoxide, and wherein even more preferably the one or more precursor compounds of zirconia is zirconium(IV)-propoxide. Concerning the zirconium salts which may be employed in the inventive process which do not form a complex with the counter-ion, in one or more embodiments said zirconium salts contain the zirconyl cation, wherein according to one or more embodiments the one or more precursor compounds of zirconia comprise one or more zirconyl salts, in other embodiments one or more zirconyl halides, in specific embodiments zirconyl bromide and/or zirconyl halide, and in more specific embodiments zirconyl chloride.

Concerning the mixture provided in step (1) of the inventive process, there is also no particular restriction which would apply relative to any further compounds which may be contained therein, provided that mixed oxide particles according to any of the embodiments of the present invention may be formed in step (3). Thus, any suitable auxiliary agent may further be comprised in the mixture of step (1) and/or any further compound or compounds may be provided therein for incorporation into the mixed oxide particles formed in step (3) of the inventive process. In this respect, in one or more embodiments, the one or more transition metal-containing compounds is provided in step (1) as precursor compounds for the incorporation of said one or more transition metals into the mixed oxide particles generated in step (3) of the inventive process. According to specific embodiments, one or more platinum group metals are included in the mixture of step (1) for incorporation thereof in the metal oxide particles resulting from the inventive process. According to the present invention, in one or more embodiments, the one or more platinum group metals are, in one or more embodiments, selected from the group consisting of Ru, Rh, Pd, Os, Ir, Pt, and mixtures of two or more thereof, in other embodiments from the group consisting of Rh, Pd, Pt, and mixtures of two or more thereof, wherein, in specific embodiments, the platinum group metal is Pd and/or Pt, preferably Pd.

Regarding the embodiments of the inventive process, wherein one or more transition metals and in particular one or more platinum group metals is further added to the mixture provided in step (1) of the inventive process, there is in principle no particular restriction as to the amounts in which said one or more metals may be added thereto, provided that mixed oxide particles according to embodiments of the present invention may be formed in step (3) of the inventive process, in particular with respect to the content of the rare earth oxides other than ceria and/or of yttria in the mixed oxide particles formed in step (3). Thus, by way of example, the one or more transition metals and in particular the one or more platinum group metals may be included in the mixture provided in step (1) in an amount ranging anywhere from 0.01 to 15 wt.-% calculated as the metal based on the total weight of the mixture provided in step (1), wherein, in one or more embodiments, the amount thereof is comprised in the range of from 0.05 to 14 wt.-%, in other embodiments from 0.1 to 13 wt.-%, in further embodiments from 0.5 to 12 wt.-%, in still further embodiments from 2 to 10 wt.-%, in specific embodiments from 3 to 9 wt.-%, and in very specific embodiments from 4 to 8 wt.-%. According to specific embodiments of the present invention, the mixture provided in step (1) comprises the one or more transition metals and in particular the one or more platinum group metals in an amount ranging from 5 to 7 wt.-%. According to alternative embodiments, on the other hand, the amount of the one or more transition metals and in particular the one or more platinum group metals comprised in the mixture provided in step (1) comprised in the range of from 0.01 to 6 wt.-% calculated as the metal based on the total weight of the mixture provided in step (1), and, specific embodiments, in the range of from 0.05 to 4 wt.-%, more specifically of from 0.08 to 3 wt.-%, even more specifically of from 0.09 to 2.5 wt.-%, and of from 0.1 to 2 wt.-%.

As regards the pyrolysis performed in step (3) of the inventive process, there is no particular restriction as to the temperature at which said step is performed, provided that mixed oxide particles according to the embodiments of the present invention are produced therein, in particular with respect to the content of the rare earth oxides other than ceria and/or of yttria contained therein. Thus, by way of example, the temperature at which the pyrolysis is performed may be comprised in the range of anywhere from 800 to 2,200° C., wherein, in one or more embodiments, the temperature in step (3) is comprised in the range of from 900 to 1,800° C., in other embodiments from 950 to 1,500° C., and in specific embodiments from 1,000 to 1,300° C. According to specific embodiments of the present invention, pyrolysis in step (3) is performed at a temperature comprised in the range of from 1,050 to 1,150° C.

In addition to providing a process for the production of mixed oxide particles, the present invention further relates to the mixed oxide particles per se which are obtained according to the inventive process as well as to mixed oxide particles which are obtainable according to any of the embodiments of the inventive process irrespective of the actual method according to which the mixed oxide particles are actually produced.

Therefore, the present invention also relates to mixed oxide particles obtainable and/or obtained, according to any of the embodiments of the inventive process.

Furthermore, the present invention also relates to mixed oxide particles obtainable from flame-spray pyrolysis, wherein the particles comprise ceria, zirconia, and one or more oxides of one or more rare earth elements other than Ce, and/or yttria, wherein the content of the rare earth oxides other than ceria, and/or of yttria in the mixed oxide calculated as their respective oxides is comprised in the range of from 0.1 to 4.9 wt.-% based on the total weight of the one or more rare earth oxides, zirconia, and optional yttria contained in the mixed oxide particles, in one or more embodiments from 0.3 to 4.5 wt.-%, in other embodiments from 0.5 to 4 wt.-%, in further embodiments from 0.7 to 3.5 wt.-%, in specific embodiments from 0.8 to 3 wt.-%, in very specific embodiments from 0.9 to 2.5 wt.-%, and even more specific embodiments from 1 to 2 wt.-%.

According to specific embodiments of the present invention, the mixed oxide particles are obtainable from flame-spray pyrolysis according to one or more embodiments of the inventive process, wherein said specific pyrolysis method is at least partly applied in step (3) for obtaining mixed oxide particles according to any of the embodiments of the present invention.

Regarding the one or more oxides of one or more rare earth elements other than ceria which may be comprised in the mixed oxide particles, there is no particular restriction according to the present invention neither with respect to the type nor with respect to the number of the one or more rare earth oxides other than ceria which may be comprised therein. According to the present invention, in one or more embodiments, said one or more rare earth oxides other than ceria comprise one or more of lanthana, praseodymia, and neodymia, including mixtures of two or three thereof, wherein, in specific embodiments, the one or more rare earth oxides other than ceria comprise lanthana and/or neodymia. According to specific embodiments of the present invention, the one or more rare earth oxides other than ceria include lanthana, wherein even more preferably the rare earth oxide other than ceria is lanthana.

Therefore, according to one or more embodiments of the mixed oxide particles according to the present invention, the one or more rare earth oxides other than ceria are selected from the group consisting of lanthana, praseodymia, neodymia, and combinations of two or three thereof, wherein one or more or more embodiments the rare earth oxides comprise lanthana and/or neodymia, wherein, in specific embodiments, the rare earth oxide other than ceria is lanthana.

No particular restriction applies according to the present invention as to the content of ceria and in particular of CeO₂ which may be contained in the mixed oxide particles such that the amount of ceria contained therein may for example range anywhere from 1 to 95 wt.-% based on the total weight of the one or more rare earth oxides, zirconia, and optional yttria contained in the mixed oxide particles. According to one or more embodiments of the present invention, the content of ceria and in particular of CeO₂ in the mixed oxide particles is comprised in the range of from 5 to 80 wt.-%, in one or more embodiments from 10 to 70 wt.-%, in other embodiments from 30 to 60 wt.-%, in further embodiments from 40 to 55 wt.-%, and in more specific embodiments from 45 to 52 wt.-%. According to specific embodiments of the present invention, the content of ceria and in particular of CeO₂ in the mixed oxide particles is comprised in the range of from 47.5 to 50.5 wt.-% based on the total weight of the one or more rare earth oxides, zirconia, and optional yttria contained in the mixed oxide particles. As regards the content of ceria in the mixed oxide particles, said content may in principle relate to any form of ceria and in particular to CeO₂, Ce₂O₃, and any mixture of said cerium oxides, wherein the content of ceria in the mixed oxide particles of the present invention preferably refer to the cerium (IV) oxide CeO₂.

According to other specific embodiments of the present invention, and in particular relative to embodiments of the mixed oxide particles for use in oxidative applications, in particular in the field of automotive exhaust gas treatment, and even more particularly as oxidation catalyst and in one or more embodiments for use in diesel oxidation catalysts (DOC), the content of ceria and in particular of CeO₂ in the mixed oxide particles is comprised in the range of from 5 to 99 wt.-% based on the total weight of the one or more rare earth oxides, zirconia and optional yttria contained in the mixed oxide particles, in other embodiments from 15 to 98 wt.-%, in specific embodiments from 30 to 95 wt.-%, in more specific embodiments from 40 to 90 wt.-%, and in very specific embodiments from 45 to 87 wt.-%. According to said embodiments of the present invention, it is specific that the content of ceria in the mixed oxide particles and in particular of CeO₂ is comprised in the range of from 50 to 80 wt.-%.

According to a further alternative embodiment of the present invention, and in particular to embodiments of the mixed oxide particles for use as oxygen storage components in the field of automotive exhaust gas treatment and in particular for use as an oxygen storage component in three-way catalysts (TWC), the content of ceria and in particular of CeO₂ in the mixed oxide particles is comprised in the range of from 1 to 80 wt.-% based on the total weight of the one or more rare earth oxides, zirconia, and optionally yttria contained in the mixed oxide particles, in one or more embodiments from 5 to 70 wt.-%, in other embodiments from 10 to 60 wt.-%, in further embodiments from 15 to 55 wt.-%, and in specific embodiments from 18 to 50 wt.-%. According to specific embodiments of said alternative embodiments, the content of ceria and in particular of CeO₂ in the mixed oxide particles is comprised in the range of from 20 to 45 wt.-%.

As regards the content of zirconia in the mixed oxide particles, as for ceria, there is no particular restriction in this respect provided that a mixed oxide particle according to any of the embodiments of the present invention is provided. Thus, by way of example, the content of zirconia in the mixed oxide particles is comprised in the range of anywhere from 1 to 95 wt.-% based on the total weight of the one or more rare earth oxides, zirconia, and optional yttria contained in the mixed oxide particles, wherein within the meaning of the present invention, the term “zirconia” generally refers to zirconia, hafnia, and mixtures thereof, wherein according to a definition said term designates the chemical compound ZrO₂. According to the present invention, in one or more embodiments, however, zirconia is contained in the mixed oxide particles in an amount comprised in the range of from 5 to 80 wt.-%, and in other embodiments from 10 to 70 wt.-%, in further embodiments from 30 to 60 wt.-%, in specific embodiments from 40 to 55 wt.-%, and in more specific embodiments from 43 to 52 wt.-%. According to one or more embodiments of the present invention, the content of zirconia in the mixed oxide particles is comprised in the range of from 45 to 51.5 wt.-%. According to other embodiments of the present invention, and in particular relative to embodiments of the mixed oxide particles for use in oxidative applications, in particular in the field of automotive exhaust gas treatment, and even more particularly as oxidation catalyst and especially for use in diesel oxidation catalysts (DOC), the content of zirconia in the mixed oxide particles is comprised in the range of from 0.5 to 80 wt.-% based on the total weight of the one or more rare earth oxides, zirconia, and optional yttria contained in the mixed oxide particles, wherein, in one or more embodiments, the content of zirconia in the mixed oxide particles is comprised in the range of from 1 to 70 wt.-%, in other embodiments from 5 to 60 wt.-%, in specific embodiments from 10 to 55 wt.-%, and in more specific embodiments from 13 to 50 wt.-%. According to one or more embodiments of said alternative embodiments, the content of zirconia in the mixed oxide particles is comprised in the range of from 15 to 45 wt.-%.

According to further alternative embodiments of the present invention, and in particular to embodiments of the mixed oxide particles for use as oxygen storage components in the field of automotive exhaust gas treatment and in particular for use as an oxygen storage component in three-way catalysts (TWC), the content of zirconia in the mixed oxide particles is comprised in the range of from 5 to 95 wt.-% based on the total weight of the one or more rare earth oxides, zirconia, and optional yttria contained in the mixed oxide particles, wherein, in one or more embodiments, the content of zirconia is comprised in the range of from 15 to 90 wt.-% and in other embodiments from 30 to 85 wt.-%, in specific embodiments from 40 to 80 wt.-% and in very specific embodiments from 45 to 77 wt.-%. According to said embodiments, it is specific that the content of zirconia in the mixed oxide particles is comprised in the range of from 50 to 75 wt.-%.

As regards the surface area of the mixed oxide particles according to the present invention, there is no particular restriction as to the surface area which the mixed oxide particles may display such that surface areas and in particular surface areas determined according to the BET method, may be comprised in the range of anywhere from 2 to 200 m²/g, wherein, in one or more embodiments, surface areas and in particular BET surface areas range from 5 to 150 m²/g, and in other embodiments range from 10 to 110 m²/g, and in further embodiments range from 20 to 95 m²/g, and in specific embodiments range from 50 to 90 m²/g. According to specific embodiments of the present invention, the surface area and in particular the BET surface area of the mixed oxide particles is comprised in the range of from 80 to 87 m²/g. Regarding the surface areas of the mixed oxide particles according to the present invention, it is noted that said values relate in particular to embodiments of the mixed oxide particles for use as an oxidation catalyst in the treatment of automotive exhaust gases and in particular for use in diesel oxidation catalysts. According to other embodiments of the present invention, the mixed oxide particles display a surface area and in particular a BET surface area comprised in the range of from 20 to 100 m²/g, and in one or more embodiments from 30 to 90 m²/g, in other embodiments from 40 to 85 m²/g, and in specific embodiments of from 45 to 80 m²/g. According to said embodiments, the surface area and in particular the BET surface area of the mixed oxide particles is comprised in the range of from 50 to 75 m²/g. As regards said embodiments of the mixed oxide particles according to the present invention, it is noted that said embodiments are particularly adapted for use as oxygen storage components in exhaust gas treatment applications and in particular for use as an oxygen storage component in three-way catalysts. As regards the BET surface area as defined in the present invention, it is noted that this refers in particular to a BET surface area determined according to DIN 66135.

Concerning the dimensions of the mixed oxide particles according to the present invention, in principle these may adopt any conceivable values. According to the present invention, in one or more embodiments, however, the mixed oxide particles are microcrystalline, wherein in one or more embodiments the average particle size of the mixed oxide particles is comprised in the range of from 5 to 100 nm, and in one or more embodiments from 6 to 50 nm, in other embodiments from 7 to 30 nm, in further embodiments from 8 to 20 nm, in specific embodiments from 9 to 50 nm, and in more specific embodiments from 10 to 30 nm. According to one or more embodiments of the present invention, the mixed oxide particles display an average particle size comprised in the range of from 11 to 12.5 nm As regards the values of the average particle size as defined in the present application, these refer in particular to the average particle size of the mixed oxide particles as obtained using the Scherrer formula as follows:

$$τ = \frac{K λ}{β cos θ}$$

wherein K is the shape factor, lambda (λ) is the X-ray wave length, beta (β) is the line broadening at half the maximum intensity (FWHM) in radians, and theta (θ) is the Bragg angle. As regards tau (τ) this stands for the mean size of the ordered (crystalline) domains, which may be smaller or equal to the grain size. The dimensionless shape factor has a typical value of about 0.9, and may be adapted to the actual shape of the crystallite if necessary.

Concerning the state of ceria, zirconia, and of the one or more oxides of one or more rare earth elements other than cerium and/or of yttria, said components are at least in part contained in the mixed oxide particles as a mixed oxide and in particular as a solid solution. This applies in particular to the ceria and zirconia in the mixed oxide particles and in specific embodiments to ceria, zirconia, the one or more oxides of one or more rare earth elements other than cerium, and/or yttria, all of which form a mixed oxide in the form of a solid solution. In this quality, the crystalline phases formed in the mixed oxide particles are accordingly crystalline phases formed by the mixed oxides and in particular by the ceria-zirconia mixed oxides. As a result, the crystalline phase of the mixed oxide particles made a tetragonal and/or a cubic structure in particular as determined by X-ray diffraction, wherein typically at least part of the crystalline mixed oxide is in the cubic phase. In fact, it has quite surprisingly been found that as opposed to ceria-zirconia mixed oxides containing one or more oxides of one or more rare earth elements other than cerium, and/or yttria, wherein the content of the latter exceeds the inventive range of 0.1 to 4.9 wt.-% according to the present application, such mixed oxide particles are mainly in the cubic phase, and in particular are entirely converted to the cubic phase upon ageing. According to the present invention, it has however been found that mixed oxide particles wherein the content of the rare earth oxides other than ceria, and/or of yttria is comprised in the range of from 0.1 to 4.9 wt.-% based on the total weight of the one or more rare earth oxides, zirconia, and optional yttria contained in the mixed oxide particles display an exceptionally low content of the cubic phase. Furthermore, it has quite unexpectedly been found that upon ageing of the inventive materials, the content of the cubic phase only gradually increases such that even after ageing a considerable proportion of the crystalline phase in the mixed oxide is not in a cubic state and, in particular, is still in a tetragonal state. Thus, without being bound to theory, it would appear that the surprising technical effects achieved by the very low content of the one or more oxides of one of more rare earth elements other than cerium, and/or of yttria in the inventive materials may very well be due to the exceptionally low proportion of the cubic phase in the crystalline material which is quite unexpectedly stabilized by said low contents of the one or more oxides of one or more rare earth elements other than cerium, and/or of yttria even after ageing.

Accordingly, as regards the proportion of the cubic phase in the mixed oxide particles of the present invention, said proportion as determined according to the Rietveld method is comprised in the range of from 0.1 to 29 percent, and in one or more embodiments in the range of from 0.5 to 25 percent, in other embodiments from 1 to 20 percent, in further embodiments from 2 to 15 percent, in specific embodiments from 3 to 10 percent, and in more specific embodiments from 4 to 8 percent. According to specific embodiments according to the present invention, the proportion of the cubic phase in the mixed oxide particles as determined according to the Rietveld method is comprised in the range of from 5 to 6 percent. Furthermore, as regards the determination of the proportion of the cubic phase according to the Rietveld method, in one or more embodiments the composition of the mixed oxide particle is employed as a constraint when determining said proportion of the cubic phase.

For determining the proportion of the cubic phase in the mixed oxide particles according to the Rietveld method, in one or more embodiments that for determining the crystalline phases and their microstructure via X-ray diffraction, the Rietveld-Software TOPAS v4.1 (Bruker AXS) is employed. In particular, in one or more embodiments a model consisting of the cubic CeO₂ structure wherein the lattice parameters and the size of the crystallites are freely refined is used. More specifically, the refinement reduces the weighted error square between the measured and simulated data points. The alignment of the calculated curve to the measured data is examined with respect to deviations, in particular in the region of 43° 2Theta. It is at this diffraction angle that the only free reflex of the tetragonal modification Ce_{0.5}Zr_{0.5}O₂ may be found. In the event that the difference curve indicates the presence of this phase, it is then introduced into the model and a quantification of both phases is carried out. In the quantification, the errors lie around 1 wt.-% and the relative errors in the calculation of the size of the crystallites around 15%.

Furthermore, as regards the proportion of the cubic phase after ageing of the mixed oxide particles, in one or more embodiments said proportion is comprised in the range of from 30 to 100 percent, and in other embodiments from 35 to 99 percent, in further embodiments from 38 to 90 percent, and in specific embodiments from 40 to 60 percent. Within the meaning of the present invention, the term “mixed oxide” refers to a single solid solution of different oxides. According to specific embodiments of the present invention, the proportion of the cubic phase as determined according to the Rietveld method after ageing of the mixed oxide particles is comprised in the range of from 42 to 45 percent. According to one or more embodiments of the present invention, the values defined for the proportion of the cubic phase of the mixed oxide particles after ageing specifically refer to those values obtained after ageing of the mixed oxide particles having a proportion of the cubic phase as determined according to the Rietveld method in the fresh state prior to ageing comprised in any of the ranges according to the present invention, wherein the specific ageing treatment performed on said mixed oxide particles in the fresh state involves the exposure thereof at 1,100° C. to air containing 10 percent H₂O and preferably 10 volume percent H₂O for a period of 40 hours.

Regarding the use of the mixed oxide particles according to the present invention, there is no restriction whatsoever as to the applications or methods in which the inventive materials may be used. According to one or more embodiments of the present invention, however, the mixed oxide particles are used as a catalyst and/or as a catalyst support. Alternatively, the mixed oxide particles are used as an oxygen storage component involving the reversible uptake of oxygen, wherein the application as an oxygen storage component relates to a particular use of the inventive materials in catalytic applications either as a catalyst and/or as a catalyst support. Thus, according to specific embodiments of the present invention, the mixed oxide particles according to any of the embodiments of the present invention are employed as an oxygen storage component and/or as a catalyst or catalyst component. Regarding said uses, there is again principally no restriction whatsoever as to the specific applications and/or methods in which the inventive materials may act as an oxygen storage component and/or as a catalyst or catalyst component, wherein the inventive materials are used as such in catalysts for the treatment of exhaust gas and, in particular, in the treatment of automotive exhaust gas. According to said embodiments, the inventive materials are used as an oxygen storage component and/or as a catalyst or catalyst component in a three way catalyst and/or in a diesel oxidation catalyst.

Therefore, the present invention further relates to the use of mixed oxide particles according to any of the embodiments as defined in the present application as an oxygen storage component, a catalyst and/or as a catalyst support, in one or more embodiments as an oxygen storage component and/or as a catalyst or catalyst component in a three way catalyst and/or diesel oxidation catalyst for the treatment of exhaust gas, particularly of automotive exhaust gas.

The present invention includes the following embodiments, wherein these include the specific combinations of embodiments as indicated by the respective interdependencies defined therein:
1. A process for the production of mixed oxide particles comprising:
   (1) providing a mixture comprising a solvent, one or more precursor compounds of ceria, one or more precursor compounds of zirconia, and one or more precursor compounds of one or more rare earth oxides other than ceria and/or one or more precursor compounds of yttria;
   (2) forming an aerosol of the mixture provided in step (1); and
   (3) pyrolyzing the aerosol of step (2) to obtain mixed oxide particles; wherein the content of the rare earth oxides other than ceria and/or of yttria in the mixed oxide particles formed in step (3) is in the range of from 0.1 to 4.9 wt.-% based on the total weight of the rare earth oxides, yttria, and zirconia contained in the mixed oxide particles, preferably of from 0.3 to 4.5 wt.-%, more preferably of from 0.5 to 4 wt.-%, more preferably of from 0.7 to 3.5 wt.-%, more preferably of from 0.8 to 3 wt.-%, more preferably of from 0.9 to 2.5 wt.-%, and more preferably of from 1 to 2 wt.-%.
2. The process of embodiment 1, wherein the one or more rare earth oxides other than ceria is selected from the group consisting of lanthana, praseodymia, neodymia, and mixtures of two or three thereof, wherein the one or more rare earth oxides preferably comprises lanthana and/or neodymia, preferably lanthana, wherein even more preferably the rare earth oxide other than ceria is lanthana.
3. The process of embodiment 1 or 2, wherein the concentration of the one or more precursor compounds of the one or more rare earth oxides other than ceria and/or of the one or more precursor compounds of yttria calculated as the respective oxides contained in the mixture provided in step (1) is comprised in the range of from to 0.01 to 5 wt.-% based on the total weight of the mixture provided in step (1), preferably of from 0.05 to 2 wt.-%, more preferably of from 0.1 to 1.5 wt.-%, more preferably of from 0.3 to 1.2 wt.-%, more preferably of from 0.5 to 1 wt.-%, more preferably of from 0.7 to 0.9 wt.-%, and even more preferably of from 0.75 to 0.85 wt.-%.
4. The process of any of embodiments 1 to 3, wherein the solvent comprises one or more selected from the group consisting of aliphatic and aromatic hydrocarbons, alcohols, heterocyclic compounds, carboxylic acids, water, and mixtures of two or more thereof, preferably from the group consisting of aromatic hydrocarbons, N-containing heterocycles, tetrahydrofurane, (C₅-C₁₀)hydrocarbons, (C₁-C₅)alcohols, (C₁-C₈)carboxylic acids, water, and combinations of two or more thereof, more preferably from the group consisting of (C₆-C₁₂) aromatic hydrocarbons, pyrrolidine, pyrrole, piperidine, pyridine, azepane, azepine, tetrahydrofurane, (C₅-C₇)hydrocarbons, (C₁-C₃)alcohols, (C₂-C₈)carboxylic acids, water, and combinations of two or more thereof, more preferably from the group consisting of C₈ aromatic hydrocarbons, pyrrolidine, pyrrole, piperidine, pyridine, tetrahydrofurane, pentane, hexane, ethanol, methanol, propanol, (C₆-C₈)carboxylic acids, acetic acid, propionic acid, water, and combinations of two or more thereof, more preferably from the group consisting of toluene, ethylbenzene, xylene, hexane, propanol, acetic acid, C₈-carboxylic acids, propionic acid, water, and combinations of two or more thereof, and even more preferably from the group consisting of xylene, hexane, n-propanol, acetic acid, 2-ethylhexanoic acid, water, and combinations of two or more thereof.
5. The process of embodiment 4, wherein the aromatic hydrocarbons comprise one or more aromatic hydrocarbons selected from the group consisting of (C₆-C₁₂)hydrocarbons, preferably of (C₇-C₁₁)hydrocarbons, more preferably of (C₈-C₁₀)hydrocarbons, more preferably of (C₈-C₉)hydrocarbons, and even more preferably of C₈-hydrocarbons, wherein even more preferably the solvent comprises one or more aromatic hydrocarbons selected from the group consisting of toluene, ethylbenzene, xylene, mesitylene, durene, and mixtures of two or more thereof, more preferably from the group consisting of toluene, ethylbenzene, xylene, and mixtures of two or more thereof, wherein even more preferably the solvent comprises toluene and/or xylene, preferably xylene.
6. The process of embodiment 4 or 5, wherein the aliphatic hydrocarbons comprise one or more hydrocarbons selected from the group consisting of branched and/or unbranched, preferably unbranched (C₄-C₁₂)hydrocarbons, preferably of (C₅-C₁₀)hydrocarbons, more preferably of (C₆-C₈)hydrocarbons, more preferably of (C₆-C₇)hydrocarbons, and even more preferably of branched and/or unbranched, preferably unbranched C₆-hydrocarbons, wherein even more preferably the solvent comprises one or more aliphatic hydrocarbons selected from the group consisting of pentane, hexane, heptane, octane, and mixtures of two or more thereof, wherein even more preferably the aliphatic hydrocarbons comprise pentane and/or hexane, preferably hexane.
7. The process of any of embodiments 4 to 6, wherein the carboxylic acid is selected from the group consisting of (C₁-C₈) carboxylic acids, preferably from the group consisting of (C₁-C₆) carboxylic acids, more preferably from the group consisting of (C₁-C₅) carboxylic acids, more preferably from the group consisting of formic acid, acetic acid, propionic acid, butyric acid, and mixtures of two or more thereof, more preferably from the group consisting of acetic acid, propionic acid, butyric acid, 2-ethylhxanoic acid and mixtures of two or more thereof, wherein more preferably the carboxylic acid comprises acetic acid and/or propionic acid, preferably acetic acid.

8. The process of any of embodiments 1 to 7, wherein the concentration of the one or more precursor compounds of ceria calculated as CeO₂ contained in the mixture provided in step (1) is comprised in the range of from 0.1 to 15 wt.-% based on the total weight of the mixture provided in step (1), preferably of from 0.5 to 10 wt.-%, more preferably of from 1 to 7 wt.-%, more preferably of from 2 to 5 wt.-%, more preferably of from 2.5 to 4 wt.-%, more preferably of from 2.7 to 3.5 wt.-%, and even more preferably of from 3 to 3.2 wt.-%.
9. The process of any of embodiments 1 to 8, wherein the concentration of the one or more precursor compounds of zirconia calculated as ZrO₂ contained in the mixture provided in step (1) is comprised in the range of from 0.1 to 15 wt.-% based on the total weight of the mixture provided in step (1), preferably of from 0.5 to 10 wt.-%, more preferably of from 1 to 7 wt.-%, more preferably of from 2 to 5 wt.-%, more preferably of from 2.5 to 4 wt.-%, more preferably of from 2.7 to 3.5 wt.-%, and even more preferably of from 3 to 3.2 wt.-%.
10. The process of any of embodiments 1 to 9, wherein the one or more precursor compounds of ceria and/or of the rare earth oxides other than ceria and/or of yttria comprise one or more salts, preferably one or more salts selected from the group consisting of carboxylates, nitrates, carbonates, alcoholates, and chelating ligand containing complexes, wherein the carboxylates are preferably selected from (C₄-C₁₂)carboxylates, more preferably from (C₅-C₁₁)carboxylates, more preferably from (C₆-C₁₀)carboxylates, more preferably from (C₇-C₉)carboxylates, more preferably from C₈-carboxylates, more preferably from branched C₈-carboxylate, wherein more preferably the one or more precursor compounds comprise a 2-ethylhexanoate salt, and wherein even more preferably the one or more precursor compounds of ceria and/or of the rare earth oxides other than ceria, and preferably of all of the precursor compounds of the rare earth oxides provided in step (1) are 2-ethylhexanoate salts.
11. The process of embodiment 10, wherein the chelating ligand containing complexes comprise one or more chelating ligands selected from the group consisting of bi-, tri-, tetra-, penta-, and hexadentate ligands, more preferably from the group consisting of oxalate, ethylenediamine, 2,2′-bipyridine, 1,10-phenanthroline, acetylacetonate, 2,2,2-crypt, diethylenetriamine, dimethylglyoximate, EDTA, ethylenediaminetriacetate, glycinate, triethylenetetramine, tris(2-aminoethyl)amine, and combinations of two or more thereof, more preferably from the group consisting of oxalate, ethylenediamine, acetylacetonate, diethylenetriamine, dimethylglyoximate, EDTA, ethylenediaminetriacetate, glycinate, triethylenetetramine, tris(2-aminoethyl)amine, and combinations of two or more thereof, more preferably from the group consisting of oxalate, ethylenediamine, acetylacetonate, diethylenetriamine, EDTA, ethylenediaminetriacetate, triethylenetetramine, and combinations of two or more thereof, wherein even more preferably the chelating ligand containing complexes comprise acetylacetonate.
12. The process of any of embodiments 1 to 11, wherein the one or more precursor compounds of zirconia comprise one or more salts, preferably one or more salts selected from the group consisting of carboxylates, nitrates, carbonates, alcoholates, and chelating ligand containing complexes, preferably diketone ligand containing complexes, and more preferably acetylacetonate complexes, wherein the alcoholates are preferably selected from (C₂-C₅) alcoholates, more preferably from (C₃-C₄) alcoholates, and more preferably from C₃-alcoholates, wherein more preferably the one or more precursor compounds comprise zirconium(IV)-propoxide, and wherein even more preferably the one or more precursor compounds of zirconia is zirconium(IV)-propoxide.
13. The process of any of embodiments 1 to 12, wherein the mixture provided in step (1) further comprises one or more platinum group metals, preferably one or more platinum group metals selected from the group consisting of Ru, Rh, Pd, Os, Ir, Pt, and mixtures of two or more thereof, more preferably from the group consisting of Rh, Pd, Pt, and mixtures of two or more thereof, wherein more preferably the platinum group metal is Pd and/or Pt, preferably Pd.
14. The process of embodiment 13, wherein the mixture provided in step (1) comprises the one or more platinum group metals in an amount ranging from 0.01 to 15 wt.-% calculated as the metal based on the total weight of the mixture provided in step (1), preferably from 0.05 to 14 wt.-%, more preferably from 0.1 to 13 wt.-%, more preferably from 0.5 to 12 wt.-%, more preferably from 2 to 10 wt.-%, more preferably from 3 to 9 wt.-%, more preferably from 4 to 8 wt.-%, and even more preferably from 5 to 7 wt.-%.
15. The process of any of embodiments 1 to 14, wherein pyrolysis in step (3) is performed in an atmosphere containing oxygen.
16. The process of any of embodiments 1 to 15, wherein pyrolysis in step (3) is performed at a temperature comprised in the range of from 800 to 2,200° C., preferably of from 900 to 1,800° C., preferably of from 950 to 1,500° C., more preferably of from 1,000 to 1,300° C., and even more preferably of from 1,050 to 1,150° C.
17. Mixed oxide particles obtainable and/or obtained, preferably obtained by a process according to any of embodiments 1 to 16.
18. Mixed oxide particles obtainable from flame spray pyrolysis, preferably according to any of embodiments 1 to 16, wherein the particles comprise ceria, zirconia, and one or more oxides of one or more rare earth elements other than Ce, and/or yttria, wherein the content of the rare earth oxides other than ceria, and/or of yttria in the mixed oxide calculated as their respective oxides is comprised in the range of from 0.1 to 4.9 wt.-% based on the total weight of the one or more rare earth oxides, zirconia, and optional yttria contained in the mixed oxide particles, preferably of from 0.3 to 4.5 wt.-%, more preferably of from 0.5 to 4 wt.-%, more preferably of from 0.7 to 3.5 wt.-%, more preferably of from 0.8 to 3 wt.-%, more preferably of from 0.9 to 2.5 wt.-%, and even more preferably of from 1 to 2 wt.-%.
19. The mixed oxide particles of embodiment 17 or 18, wherein the one or more rare earth oxides other than ceria are selected from the group consisting of lanthana, praseodymia, neodymia, and combinations of two or three thereof, wherein the one or more rare earth oxides preferably comprise lanthana and/or neodymia, preferably lanthana, wherein even more preferably the rare earth oxide other than ceria is lanthana.
20. The mixed oxide particles of any of embodiments 17 to 19, wherein the content of ceria in the mixed oxide particles is comprised in the range of from 1 to 95 wt.-% based on the total weight of the one or more rare earth oxides, zirconia, and optional yttria contained in the mixed oxide particles, preferably from 5 to 80 wt.-%, more preferably from 10 to 70 wt.-%, more preferably from 30 to 60 wt.-%, more preferably from 40 to 55 wt.-%, more preferably from 45 to 52 wt.-%, more preferably from 47.5 to 50.5 wt.-%.
21. The mixed oxide particles of any of embodiments 17 to 20, wherein the content of ZrO₂ in the mixed oxide particles is comprised in the range of from 1 to 95 wt.-% based on the total weight of the one or more rare earth oxides, zirconia, and optional yttria contained in the mixed oxide particles, preferably from 5 to 80 wt.-%, more preferably from 10 to 70 wt.-%, more preferably from 30 to 60 wt.-%, more preferably from 40 to 55 wt.-%, more preferably from 43 to 52 wt.-%, more preferably from 45 to 51.5 wt.-%.
22. The mixed oxide particles of any of embodiments 17 to 21, wherein the BET surface area of the mixed oxide particles is comprised in the range of from 2 to 200 m²/g, preferably of from 5 to 150 m²/g, more preferably of from 10 to 110 m²/g, more preferably of from 20 to 95 m²/g, more preferably of from 50 to 90 m²/g, and even more preferably of from 80 to 87 m²/g.
23. The mixed oxide particles of any of embodiments 17 to 22, wherein the average particle size of the mixed oxide particles is comprised in the range of from 5 to 100 nm, preferably of from 6 to 50 nm, more preferably of from 7 to 30 nm, more preferably of from 8 to 20 nm, more preferably of from 9 to 15 nm, more preferably of from 10 to 13 nm, and even more preferably of from 11 to 12.5 nm, wherein preferably the average particle size is obtained using the Scherrer formula.
24. The mixed oxide particles of any of embodiments 17 to 23, wherein the proportion of the cubic phase as determined according to the Rietveld method is comprised in the range of from 0.1 to 29%, preferably of from 0.5 to 25%, more preferably of from 1 to 20%, more preferably of from 2 to 15%, more preferably of from 3 to 10%, more preferably of from 4 to 8%, and even more preferably of from 5 to 6%.
25. The mixed oxide particles of embodiment 24, wherein the proportion of the cubic phase as determined according to the Rietveld method after aging of the mixed oxide particles is comprised in the range of from 30 to 100%, preferably of from 35 to 99%, more preferably of from 38 to 90%, more preferably of from 40 to 60%, and even more preferably of from 42 to 45%, wherein aging is preferably performed by heating the mixed oxide particles at 1,100° C. in air with 10% H₂O for 40 h.
26. Use of mixed oxide particles according to any of embodiments 17 to 25 as an oxygen storage component, a catalyst and/or as a catalyst support, preferably as an oxygen storage component and/or as a catalyst or catalyst component in a three way catalyst and/or diesel oxidation catalyst for the treatment of exhaust gas, preferably of automotive exhaust gas.

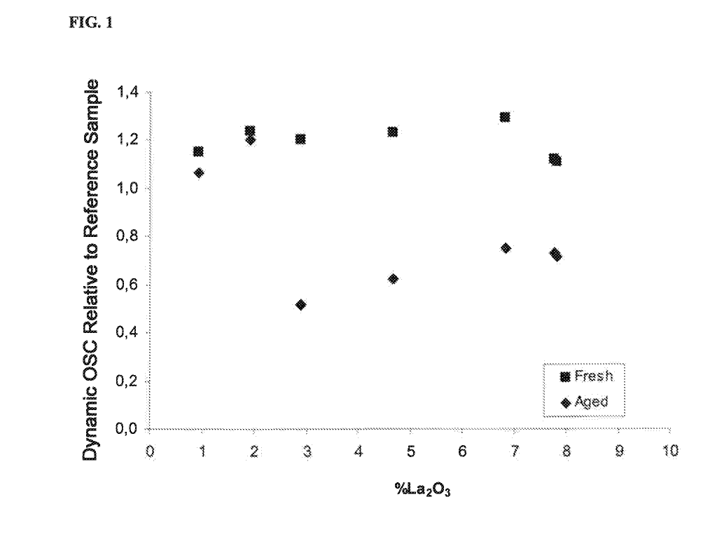

Referring to the figures, FIG. 1 shows the oxygen storage capacity of ceria-zirconia mixed oxide materials obtained from flame spray pyrolysis according to Examples 1 to 4 and Comparative Examples 2 to 5 compared to a sample according to the prior art obtained from a co-precipitation method as reference depending on the amount of the lanthana additive contained in the ceria-zirconia mixed oxide materials. In FIG. 1, the content of lanthana in weight along the abscissa and the oxygen storage capacity relative to the reference material is plotted against the ordinate. Regarding the tested samples, the oxygen storage capacity of the as-synthesized materials in their fresh state as indicated by the symbol “▪” whereas the oxygen storage capacity of the aged materials is indicated by the symbol “♦”.

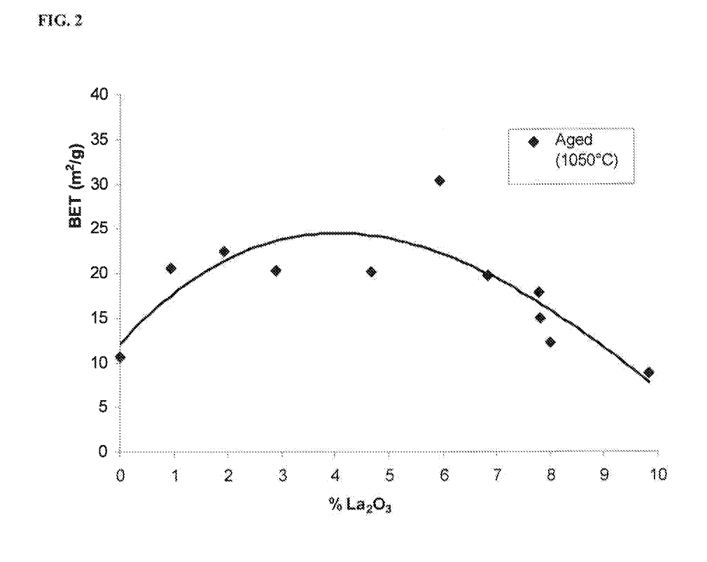

FIG. 2 shows the BET-surface area of Examples 1 to 4 and Comparative Examples 2 to 6 after aging relative to the amount of lanthana contained in the ceria-zirconia mixed oxides as additive. In FIG. 2, the BET-surface area in m²/g is plotted along the ordinate whereas the content of lanthana in the ceria-zirconia mixed oxide materials is shown along the abscissa.

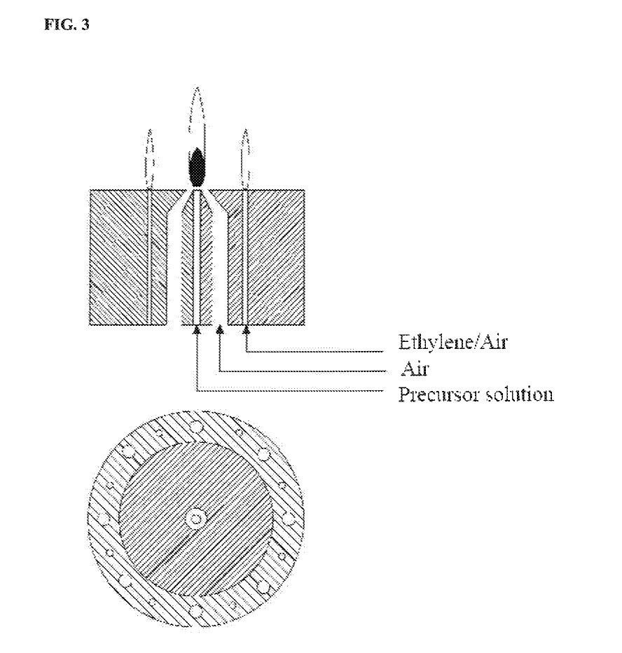

FIG. 3 displays the burner configuration (top and side view) in an apparatus which may be employed for flame spray pyrolysis.

### Examples

For the synthesis of the mixed oxide particles in the experimental section, a flame spray pyrolysis apparatus as depicted in FIG. 3 was employed. More specifically, the nozzles for the flame spray pyrolysis are located in the upper portion of a burning chamber. As indicated in FIG. 3 (top view), the main nozzle for the vaporization of the precursor is located in the middle of the nozzle arrangement. Two lines are connected to said main nozzle wherein the first line is connected to a piston pump for pumping the precursor solution into the chamber. The second line provides air wherein the oxygen content thereof may be varied by the injection of oxygen or nitrogen therein. Both lines converge in the main nozzle. Further nozzles are arranged around said main nozzle, wherein in the first half of said nozzles a gas mixture of air/oxygen/nitrogen is introduced and in the second half ethylene, respectively. The further nozzles provide auxiliary flames for providing a constant temperature and a uniform combustion in the burning chamber. In the lower portion of the burning chamber, a quench portion is provided for rapid cooling of the particles generated in the upper portion of the burning chamber.

For determining the proportion of the cubic phase in the mixed oxide particles according to the Rietveld method, the crystalline phases of the samples and their microstructure were examined via X-ray diffraction. To this effect, the samples were analyzed in a D8 Advance (Bruker AXS) Bragg-Brentano diffractometer with a resolution of about 0.05° 2Theta. The powder samples were filled into a sample container and smoothed out using a glass plate. The reflection data was then collected in the range from 5 to 80° 2Theta and the data evaluated with the Rietveld-Software TOPAS v4.1 (Bruker AXS). In particular, a model was used consisting of the cubic CeO₂ structure wherein the lattice parameters and the size of the crystallites are freely refined. More specifically, the weighted error square between the measured and simulated data points was reduced by refinement of the model. The alignment of the calculated curve to the measured data was examined with respect to deviations, in particular in the region of 43° 2Theta. It is at this diffraction angle that the only free reflex of the tetragonal modification Ce_{0.5}Zr_{0.5}O₂ may be found. In the event that the difference curve indicated the presence of this phase, it was then introduced into the model and a quantification of both phases was carried out. In the quantification, the errors lay around 1 wt.-% and the relative errors in the calculation of the size of the crystallites lay around 15%.

### Flame Spray Pyrolysis

In the synthesis of the examples and comparative examples, the flow of the precursor solution was set to 320 ml/h and the flow of air and ethylene to the main and auxiliary nozzles regulated such that an average temperature of 1100° C. was sustained in the burning chamber for the pyrolysis of the precursor solution. After having obtained the mixed oxide products from flame spray pyrolysis, the powders were analyzed in their fresh state after which they were subject to hydrothermal aging by exposure to air with 10 vol.-% of H₂O at a temperature of 1100° C. for 40 h. The composition of the precursor solutions as well as the characteristics of the fresh and aged products is shown in Table 1 below, wherein in particular the BET-surface area of the fresh and aged products as well as the proportion of the cubic crystalline phase of the mixed oxide materials prior to and after aging is indicated in addition to the XRD diameter of the as-synthesized materials.

TABLE 1

| | | | | | Comp. | Comp. | Comp. | Comp. | Comp. | Comp. |
|---|---|---|---|---|---|---|---|---|---|---|
| | Ex. 1 | Ex. 2 | Ex. 3 | Ex. 4 | Ex. 1 | Ex. 2 | Ex. 3 | Ex. 4 | Ex. 5 | Ex. 6 |
| Precurors | | | | | | | | | | |
| Xylene [grams] | 260 | 191 | 401 | 641 | 404 | 401 | 234 | 234 | 187 | 584 |
| 70 wt.-% | 69 | 59 | 107 | 59 | 89 | 107 | 72 | 72 | 65 | 55 |
| zirconium | | | | | | | | | | |
| (IV)-propoxide in | | | | | | | | | | |
| n-propanol | | | | | | | | | | |
| [grams] | | | | | | | | | | |
| 49 wt.-% cerium | 123 | 105 | 190 | 105 | 158 | 190 | 128 | 128 | 116 | 98 |
| (III)-2-ethyl | | | | | | | | | | |
| hexanoate in | | | | | | | | | | |
| 2-ethyl hexanoic | | | | | | | | | | |
| acid [grams] | | | | | | | | | | |
| 10 wt.-% lanthanum | 67 | 94 | 103 | 94 | 0 | 103 | 115 | 115 | 133 | 113 |
| (III)-2-ethyl | | | | | | | | | | |
| hexanoate in hexane | | | | | | | | | | |
| Product | | | | | | | | | | |
| wt.-% La₂O₃ | 0.9 | 1.9 | 2.9 | 4.7 | — | 6.8 | 7.8 | 7.8 | 8.0 | 9.8 |
| (aged) | | | | | | | | | | |
| BET-surface area | 86 | 85 | — | 87 | 85 | — | 94 | 88 | — | — |
| [m²/g] (fresh) | | | | | | | | | | |
| BET-surface area | 20.6 | 22.5 | 20.3 | 20.2 | 10.6 | 19.7 | 14.9 | 17.8 | 12.2 | 8.8 |
| [m²/g] (aged) | | | | | | | | | | |
| % cubic phase in | 5 | 6 | — | — | 7 | — | — | — | — | — |
| XRD (fresh) | | | | | | | | | | |
| % cubic phase in | 42 | 45 | 99 | 99 | 29 | 100 | 100 | 100 | — | — |
| XRD (aged) | | | | | | | | | | |
| Average particle | 12.5 | 12.5 | 11 | 11 | 11.5 | 14 | 12 | 12 | 12 | 11.5 |
| diameter via | | | | | | | | | | |
| XRD [nm] (fresh) | | | | | | | | | | |

The oxygen storage capacity of the mixed oxide materials according to the examples and comparative examples in the fresh and aged states were respectively determined. The results of said testing is indicated in FIG. 1, wherein the oxygen storage capacity is indicated relative to a sample according to the prior art obtained from a co-precipitation method as the reference material, wherein said reference sample contained 40 wt.-% ceria, 45 wt.-% zirconia, 2 wt.-% lanthana, 5 wt.-% neodymia, and 8 wt.-% yttria. Thus, as may be taken from FIG. 1, it has quite surprisingly been found that materials according to the present invention having a particularly low amount of additives in addition to ceria and zirconia not only display an oxygen storage capacity comparable to materials having a greater amount of additives in the fresh state. Quite more unexpectedly, it has been found that in the aged materials particularly low levels of an additive in the inventive materials affords an oxygen storage capacity which is clearly superior to materials produced in the same fashion yet containing higher levels of said additive, an effect which is most pronounced at additive levels of around 1 to 2 wt.-%

Consequently, as a result of said highly unexpected finding, it is actually possible to provide an improved oxygen storage component which may not only be used in a highly cost efficient manner, in particular with respect to the additive components. Quite surprisingly it is actually even possible to provide a considerably improved oxygen storage component relative to the aging stability compared to oxygen storage component materials produced with a higher amount of the additives and which would normally be expected not only to provide a greater oxygen storage capacity but in particular to allow for an improved hydrothermal stability of the resulting materials compared to such materials having little or no additive components.

Furthermore, as may be taken from the values for the BET-surface area after aging as indicated in FIG. 2, the BET-surface area of the inventive materials, an increased surface area of the aged materials compared to a sample devoid of additive is observed which may clearly compete with surface areas of aged materials containing clearly larger amounts thereof. Consequently, it is also observed relative to the hydrothermal stability of the inventive materials that quite unexpectedly the inventive materials may compete in their quality with materials having a multiple of the amount of additives and being therefore clearly less cost efficient in their production than the inventive materials.

Finally, it has quite unexpectedly been found that upon ageing of selected examples of the inventive materials (see in particular results for Examples 1 and 2 in Table 1), the content of the cubic phase only gradually increases such that even after ageing a considerable proportion of the crystalline phase in the mixed oxide is not in a cubic state and, in particular, is still in a tetragonal state. Thus, without being bound to theory, it would appear that part of the surprising technical effects achieved by the very low content of the one or more oxides of one of more rare earth elements other than cerium, and/or of yttria in the inventive materials may very well be due to exceptionally low proportions of the cubic phase in the crystalline material which is quite unexpectedly stabilized by low contents of the one or more oxides of one or more rare earth elements other than cerium, and/or of yttria even after ageing. In particular, again without being bound to theory, said highly unexpected finding would appear to correlate with the exceptional hydrothermal stability of the inventive materials, in particular as displayed for Examples 1 and 2 in FIG. 1, respectively.

Accordingly, as demonstrated above, a highly improved oxygen storage component may be obtained according to the present invention which is furthermore highly cost efficient compared to other materials in view of the very low amount of additive materials in addition to ceria and zirconia employed therein.

What is claimed is:

1. A process for the production of mixed oxide particles comprising:
(1) providing a mixture comprising a solvent, one or more precursor compounds of ceria, one or more precursor compounds of zirconia, and one or more precursor compounds of one or more rare earth oxides other than ceria and/or one or more precursor compounds of yttria;
(2) forming an aerosol of the mixture; and
(3) pyrolyzing the aerosol to obtain mixed oxide particles;
wherein the content of the rare earth oxides other than ceria and/or of yttria in the mixed oxide particles is in the range of from 0.1 to 4.9 wt.-% based on the total weight of the rare earth oxides, yttria, and zirconia contained in the mixed oxide particles.

2. The process of claim 1, wherein the one or more rare earth oxides other than ceria is selected from the group consisting of lanthana, praseodymia, neodymia, and mixtures of two or three thereof.

3. The process of claim 1, wherein the concentration of the one or more precursor compounds of the one or more rare earth oxides other than ceria and/or of the one or more precursor compounds of yttria calculated as the respective oxides contained in the mixture is comprised in the range of from to 0.01 to 5 wt.-% based on the total weight of the mixture.

4. The process of claim 1, wherein the solvent comprises one or more selected from the group consisting of aliphatic and aromatic hydrocarbons, alcohols, heterocyclic compounds, carboxylic acids, water, and mixtures of two or more thereof.

5. The process of claim 4, wherein the aromatic hydrocarbons comprise one or more aromatic hydrocarbons selected from the group consisting of (C₆-C₁₂)hydrocarbons.

6. The process of claim 4, wherein the aliphatic hydrocarbons comprise one or more hydrocarbons selected from the group consisting of branched and/or unbranched (C₄-C₁₂)hydrocarbons.

7. The process of claim 4, wherein the carboxylic acid is selected from the group consisting of (C₁-C₈) carboxylic acids.

8. The process of claim 1, wherein the concentration of the one or more precursor compounds of ceria calculated as CeO₂ contained in the mixture is comprised in the range of from 0.1 to 15 wt.-% based on the total weight of the mixture.

9. The process of claim 1, wherein the concentration of the one or more precursor compounds of zirconia calculated as ZrO₂ contained in the mixture is comprised in the range of from 0.1 to 15 wt.-% based on the total weight of the mixture.

10. The process claim 1, wherein the one or more precursor compounds of ceria and/or of the rare earth oxides other than ceria and/or of yttria comprise one or more salts.

11. The process of claim 10, wherein the chelating ligand containing complexes comprise one or more chelating ligands selected from the group consisting of bi-, tri-, tetra-, penta-, and hexadentate ligands.

12. The process of claim 1, wherein the one or more precursor compounds of zirconia comprise one or more salts.

13. The process of claim 1, wherein the mixture further comprises one or more platinum group metals.

14. The process of claim 13, wherein the mixture comprises the one or more platinum group metals in an amount ranging from 0.01 to 15 wt.-% calculated as the metal based on the total weight of the mixture.

15. The process of claim 1, wherein pyrolysis is performed in an atmosphere containing oxygen.

16. The process of claim 1, wherein pyrolysis is performed at a temperature in the range of from 800 to 2,200° C.

17. A mixed oxide particle obtained by a process according to claim 1.

18. A mixed oxide particle obtained from flame spray pyrolysis, wherein the particles comprise ceria, zirconia, and one or more oxides of one or more rare earth elements other than Ce, and/or yttria, wherein the content of the rare earth oxides other than ceria, and/or of yttria in the mixed oxide calculated as their respective oxides is comprised in the range of from 0.1 to 4.9 wt.-% based on the total weight of the one or more rare earth oxides, zirconia, and optional yttria contained in the mixed oxide particles.

19. The mixed oxide particles of claim 18, wherein the one or more rare earth oxides other than ceria are selected from the group consisting of lanthana, praseodymia, neodymia, and combinations of two or three thereof.

20. The mixed oxide particles of claim 18, wherein the content of ceria in the mixed oxide particles is comprised in the range of from 1 to 95 wt.-% based on the total weight of the one or more rare earth oxides, zirconia, and optional yttria contained in the mixed oxide particles.

21. The mixed oxide particles of claim 18, wherein the content of ZrO₂ in the mixed oxide particles is comprised in the range of from 1 to 95 wt.-% based on the total weight of the one or more rare earth oxides, zirconia, and optional yttria contained in the mixed oxide particles.

22. The mixed oxide particles of claim 18, wherein the BET surface area of the mixed oxide particles is comprised in the range of from 2 to 200 m²/g.

23. The mixed oxide particles of any of claim 18, wherein the average particle size of the mixed oxide particles is comprised in the range of from 5 to 100 nm.

24. The mixed oxide particles of claim 18, wherein the proportion of the cubic phase as determined according to the Rietveld method is comprised in the range of from 0.1 to 29%.

25. The mixed oxide particles of claim 24, wherein the proportion of the cubic phase as determined according to the Rietveld method after aging of the mixed oxide particles is comprised in the range of from 30 to 100%.

26. A method of storing oxygen, the method comprising using the mixed oxide particles of claim 18 as an oxygen storage component, a catalyst, and/or as a catalyst support.
